(19) United States
(12) Patent Application Publication
(10) Pub. No.: US 2003/0210489 A1
(43) Pub. Date: Nov. 13, 2003

(54) Data eraser and data erasing program

(75) Inventors: Tomoaki Hirakata, Machida-shi (JP); Masaru Igarashi, Machida-shi (JP); Hiroshi Takahashi, Machida-shi (JP)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: YEC CO., LTD., Tokyo (JP)

(21) Appl. No.: 10/253,241

(22) Filed: Sep. 24, 2002

(30) Foreign Application Priority Data
May 13, 2002 (JP) 2002-136452

(51) Int. Cl. G11B 5/02; G11B 5/03

(52) U.S. Cl. 360/57; 360/66

(57) ABSTRACT

A data eraser for erasing data recorded on a data recording medium, where data recorded on the recording medium can be erased in a short time period. Data produced in the CPU of the controller is stored in the memory as a random unit data; the unit data are repeatedly and continuously written in the memory to constitute record data for erasing purpose; the thus produced recording data for erasing are written on the hard disc to erase the data memorized in the hard disc. Since the time for producing random data, which normally takes time, is shortened, the time for proceeding as a whole can be shortened.

### BACKGROUND OF THE INVENTION

1) Field of the Invention

The present invention relates to a data eraser and a data erasing program for erasing data, which has been recorded on a recording medium, such as hard discs. More particularly, the present invention relates to a data eraser or a data erasing program where the time for data erasing is remarkably saved.

2) Prior Art

Recently problems frequently occur where data recorded on a recording medium in personal computers are read out when the computers are thrown away for the purpose of misusing the data. Normally, when an operator erases data on a screen of personal computers, management data of the data file where the relevant data is recorded is also erased, however the actual data itself on the recording medium, such as hard discs is not erased. Therefore, it is possible to revive the data if the portion of the medium, where the data is written, is directly read out.

In order to solve the problem, it is necessary to erase the actual data completely. For this purpose, it is conducted that special data are written on the whole area of hard disks to physically erase the data. In this case, for instance, data “0” or “1” are recorded over the data area at every one bit.

However, even though such an operation to physically erase the data is done, sometimes the data cannot be deleted in a perfect manner.

Digital data are composed of “0” or “1” and thus the signal to be read out from the recording medium is bivalent as shown in FIG. 4. When rewriting all of the bivalent data into “0”, a small difference corresponding to the condition before the data is erased, is still left between the signal “0” and the signal “1” as shown in FIG. 5, depending upon the original signal.

In case that the data are read out with the aid of personal computers, all the signals shown in FIG. 5 may be recognized as “0”, however, if the detector having a high accuracy is used to detect the small differences, the value before erasing the data could be read out. In order to perfectly erase such data, it is required to repeat the erasing procedures, such as rewriting all the data once to “0” and then all the data to “1”, which takes a long time to do.

There is another way of erasing data without leaving any trace, where random data (meaningless data) is written over the original data. However, in order to prepare random data having sufficient size to cover the whole recording area of the recording medium, the load in the CPU becomes so large that it takes a long time to erase the data. Therefore, it is difficult to delete the original data in a short time.

### SUMMARY OF THE INVENTION

The present invention has for its purpose to provide a data eraser and a computer program for erasing data recorded on a data recording medium, by which original digital data can be completely erased in a short time.

(1) The purpose of the present invention is carried out in that: the data eraser comprises a random unit data producing means for producing a predetermined unit amount of random data, a recording data producing means for producing data for erasing on the basis of said random unit data, and a data recording means for recording the thus obtained data for erasing on the recording medium.

(2) The eraser according to the invention may further comprise a data memory for storing the data for erasing, wherein said data recording means records the data for erasing stored in the data memory over the recording medium.

(3) It may be preferred that the recording medium is hard disks.

(4) It may be preferred that said predetermined unit amount of the random data is two bytes.

(5) Further, it may be preferred that the data for erasing is formed by continuously repeating the random unit data.

(6) Furthermore, it is preferred that the recording data producing means records the data for erasing over the whole recording area of the recording medium.

(7) The data eraser according to the present invention has a further characteristic in that the eraser comprises an erasing process controlling means for setting a number for repeating the erasing operation, which comprise a step for producing a new random data in the random unit data producing means, a step for preparing a new data for erasing in the recording data producing means, and a step for writing the new data for erasing over the whole area of the data recording medium.

(8) The present invention has for another purpose to provide a computer program for erasing data recording on a recording medium comprising a first step for preparing a predetermined unit amount of random data; a second step for preparing data for erasing by repeatedly collecting the thus prepared random unit data together, and a third step for recording the thus prepared data for erasing on the recording medium.

(9) The computer program according to the invention further has a characteristic in that the steps (1) to (3) are repeated a plural number of times.

### BRIEF DESCRIPTION OF THE DRAWINGS

FIG. 1 is a block diagram showing a construction of the data eraser according to the invention;

FIG. 2 is a schematic view depicting a construction of a random unit data and a construction of the recording data for erasing;

FIG. 3 is a flow chart representing an operation of the present invention;

FIG. 4 is a schematic view illustrating a condition of the recording signal before erasing data; and

FIG. 5 is a schematic view showing a condition of the recording signal after erasing the data.

### DETAILED EXPLANATION OF THE PREFERRED EMBODIMENTS

The preferred embodiments according to the present invention will be explained below.

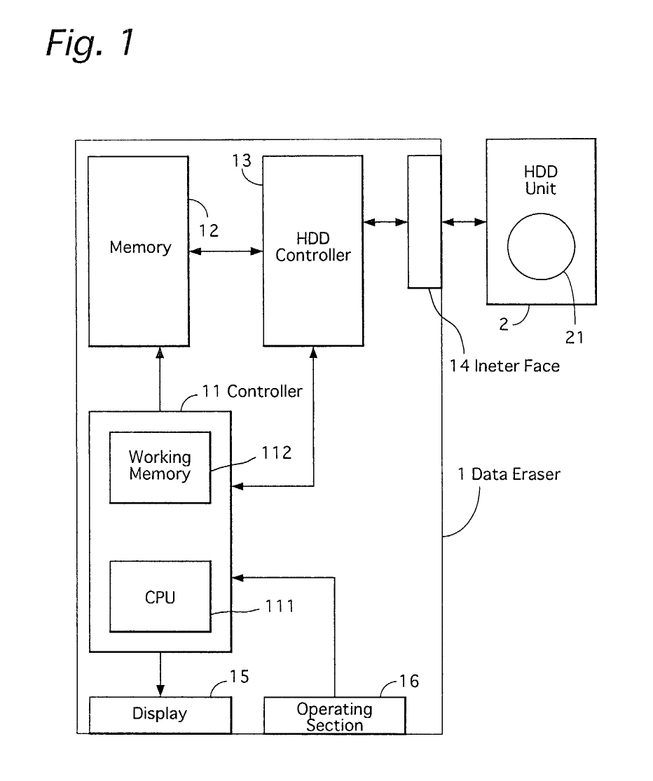

FIG. 1 is a block diagram showing the construction of the data eraser 1 according to the present invention.

The data eraser 1 according to the invention is for erasing data which has been recorded on hard disks. The data eraser 1 comprises a controller 11 having a CPU (Central Processing Unit), a memory 12, a hard disk controller 13, an interface for connecting the eraser 1 and a hard disk unit 2 together, a display 15 and an operating section 16.

The controller 11 has a memory 112 as a working area and a CPU 111. In the CPU 111 it is preliminarily determined to take two bytes as a unit amount of data, so that the unit data amount of the data produced there becomes two bytes. Two bytes of the random unit data produced in the CPU is once stored in the working memory 112, and then supplied to the memory 12. In the memory 12, the two bytes of random unit data are repeatedly and continuously stored to produce one data for erasing, which is constituted of collected random unit data.

To the controller 11, the display 15 and the operating section 16 are connected. On the display 15, conditions of the data eraser 1 are shown; for instance, the signs for that data are being erased, ON/OFF of the power supply, for errors, for the mode selected by an operator, for the fact that the erasing operation is finished, etc. These signs may be shown on the display screen, or by an on/off operation of a lamp, or a color of the lamp may also be able to be used to show the condition.

The operating section 16 comprises a power switch, a mode selecting switch, a starting switch, a reset switch, etc. The operation mode selected in the operating section 16 is supplied to the controller 11 as an operation signal. The mode selecting switch is to set a number of the erasing operation to be repeated: for instance, one, three, five, or seven times of the erasing operation can be selected. One cycle of the erasing operation comprises preparing a random unit data, preparing a data for erasing, and erasing the whole area of the hard disks. When the number of the erasing operation is set to a plural number, the cycle for erasing operation is repeatedly done up to the settled number, and every time when the cycle is repeated, new random unit data are produced.

For instance, a RAM (Random Access Memory) is used as the memory 12:

the random unit data supplied from the controller 11 is continuously recorded there to produce data for erasing. The data for erasing in the memory 12 is then supplied to the hard disk controller 13.

The hard disk controller 13 controls the drive of the hard disk unit 2, which is connected to the section 13 via the interface 14. The controller 13, for instance, confirms the connection of the hard disk unit 2, commands to start the recording operation, recognizes that the recording is finished, recognizes errors of the recording operation, writes the data for erasing, etc. These controlling operations start in accordance with a command from the controller 11. The signal recognized in the hard disk controller 13, which comes from the hard disk unit 2, is supplied to the controller 11.

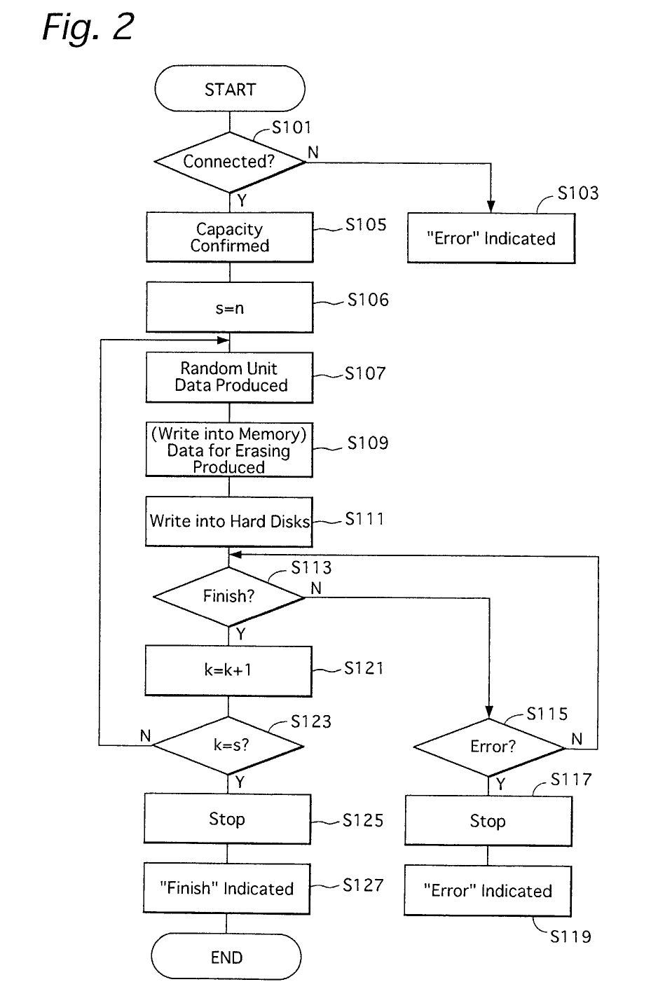

The detail operation in the data eraser 1 according to the present invention will be explained below with the flow chart shown in FIG. 2.

The connection of the hard disk unit 2 is recognized in the hard disk controller 13 (Step S101). When the controller 13 does not detect the connection of the hard disk unit 2 (Step S101, No), it is recognized that the hard disk unit 2 is not properly connected, and an error indication is displayed on the display 15 (Step S103). On the other hand, when the connection is recognized (Step S101, Yes), the capacity of the hard disk is confirmed (Step S105).

Next, the operation mode selected in the operating section 16 is recognized to confirm the number of erasing operation, then the selected number n is entered to the hard disk controller 11 as the value of s (Step S106).

The controller 11 produces two bites of random data as one unit data (Step S107). For instance, in order to produce a random data of [5] [F], two figures of hexadecimal number may be prepared in accordance with a random number producing program. While, the random unit data may be produced from the time information when the operation is carried out. For instance, if the operation starts at 11:05, a random unit data [b], [5] may be used. Any random unit data or any data for erasing can be used, unless they have any meaning for the original data. It is not required that the data must be random number data.

Since the amount of the random unit data produced in the controller 11 is only 2 bytes, it does not take a long time to produce the random unit data.

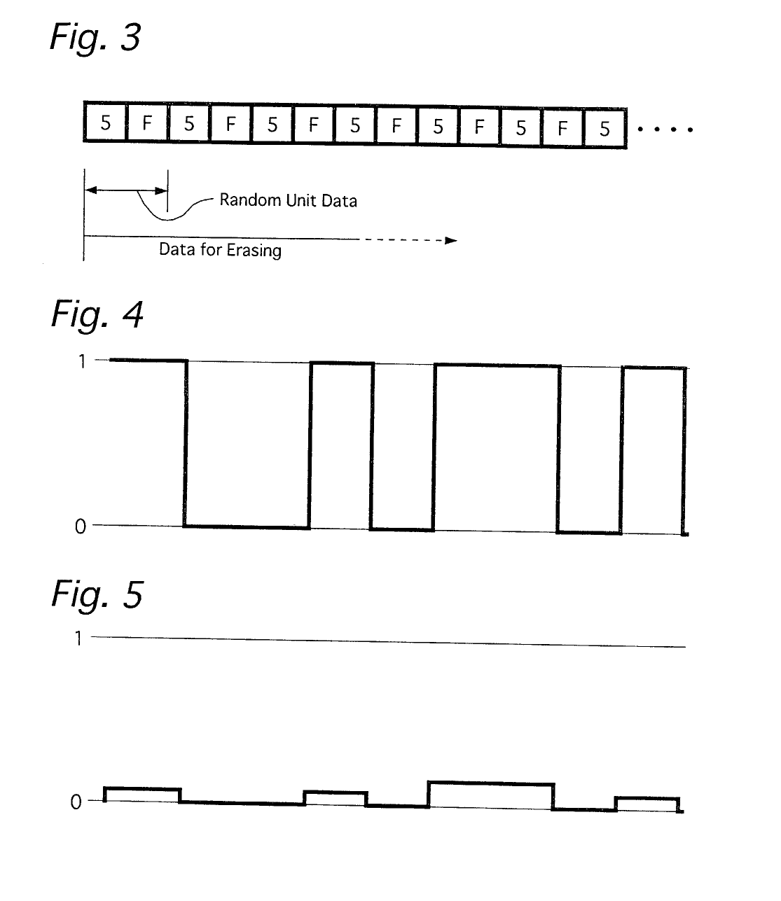

Then, the random unit data produced at the Step 107 is stored in the internal wording memory 112, and the stored random unit data is written in the memory 12 (Step S109). At this time, the random unit data is repeatedly supplied from the internal working memory 112 to the memory 12, where the random unit data are repeatedly written so as to produce a continued data as a whole to produce a data for erasing as shown in FIG. 3.

In this manner, according to the invention, the random unit data, which is already prepared, is repeatedly written to produce a data for erasing, so that the time for producing the data for erasing can be saved. More concretely, first, the data amount (unit data amount) of the random unit data is only two bytes, which is comparatively small, so that the time for producing the random unit data can be preferably made short. Second, the thus obtained random unit data is repeatedly written in the memory 12, therefore time to write a data for erasing also can be saved, because it is not necessary to prepare new random unit data each time. Third, the data for erasing can be produced by simply repeating to write the random data, which has been already prepared. Therefore, even if the amount of the recording data to be erased is very large, the data for erasing can be easily prepared, so that the time for processing can be preferably saved.

The data for erasing prepared in the memory 12 is sent to the hard disks of the hard disk unit 2 (Step S13). This process is conducted for each one block (512 bytes) of the hard disk memory capacity. Therefore, it is preferred that the memory 12 has a capacity more than one block, i.e. 512 bytes or more in this case. If the memory 12 has its capacity more than one block, it becomes possible to erase one block of the hard disk memory with one time of the data reading-out operation from the memory 12, so that the processing efficiency is improved. It is further preferred that the memory 12 has a capacity for plural of blocks, i.e. 512 byte×n (n is a natural number).

Next, the data for erasing is written over the hard disks 21 of the hard disk unit 2 (Step S111). The writing operation into the hard disks 21 is conducted for each one block. It should be noted that in the case of IDE (Integrated Device Electronics), it should be done for each one sector.

It is judged whether the data for erasing are written over the whole area of the hard disks 21 (Step S113): if the data are not written over the whole area (Step S113, No), it is further judged whether the controller received an error signal (Step S 115). When the controller 11 receives an error signal (Step S115, Yes), the hard disk unit 2 is stopped to be driven (Step S117) and then an error indication is shown on the display 15.

When the controller does not receive an error signal (Step S115, No), Step S11 is repeated again. After the data writing operation on the hard disks 21 has been finished (Step S113, Yes), the variable number k is incremented one (Step S121) and it is judged whether the variable number k reaches to the settled number (Step S123). If the number k does not reach to the settled number (Step S123, No), Steps 107 to 121 are repeated. On the other hand, when the number k becomes to the settled number (Step 123, Yes), the hard disks 21 are stopped to be driven (Step S125), and “finish” is mentioned on the display 15 (Step S127).

If it may be possible to arrange such that the data for erasing recorded over the whole area of the hard disks 21 is further rewritten into a special uniform data, for instance, data where all bytes are “1” or “0”, after Step S123. More concretely, other steps are inserted between Step S123 and S125 that data where both the two bites are “1” or “0” are prepared as random data and that he Steps S109˜S113 are performed again. By conducting the operation at the last step of the erasing procedure, it is possible to show the fact that the subjected hard disks have been completely erased in a physical manner.

The procedures in the Step S107 are performed in the random unit data preparing means; those in the step S109 are performed in the recording data preparing means; those in the steps S111 and S113 are in the recording medium recording means, and the procedures in the steps S106, S121 and S123 are realized in the erasing process controlling means. Furthermore, the Step S107 corresponds to the first step mentioned in claim 8, the Step 109 to the second step there and the Steps S111 and S113 correspond to the third step there.

The recording medium in the data eraser 1, or the recording medium where the recorded data are erased by using the data erasing program according to the invention, may be a magnetic recording medium such as hard disks, or an optical recording medium, or an opto-magnetic recording medium. In this case, such an MO drive, a CD-R drive and a DVD drive, are preferably used as external equipment to be connected to the interface.

The CPU used in the controller 11 of the above-mentioned embodiment is 16 bits CPU which produces two byte of random data, which is available with low cost. However, a 32 bits CPU can be also preferably used. In this case, 4 bytes of random data can be produced, so that it is possible to erase the data more efficiently.

Furthermore, it is also possible to arrange such that the program shown in FIG. 2 is recorded on a recording medium, which is readable with the aid of a computer, for instance a flexible disk, where the data on the hard disks installed in the personal computers are erased by the program.

In this case, an operating system program and the program according to the invention are recorded on the flexible disk; the personal computer is started up by using the operating system program and the data stored in the hard disk are erased by using the program according to the invention.

In the above-mentioned embodiment, the data for erasing are recorded over the whole area of the recording medium, such as hard disks. However, it may be arranged such that the data for erasing are recorded only on a part of the recording medium. For instance, special amount of the data for erasing may be recorded with a given distance, or in case that the data recorded portion of the hard disk to be erased is preliminarily known, the data for erasing can be recorded on that portion only. Furthermore, the portion to record the data for erasing can be determined in a random manner, so that the data is written with random distances. In this case, a part of the original data is left, however, since the data is erased in a random manner so that it will end in that the data cannot be used any more. From this point of view that the data cannot be used, it is the same effect as that of the case where all of the data is erased.

According to the invention mentioned in claims 1 to 8, random unit data is produced and repeatedly produced to obtain data for erasing, so that the time for preparing the data for erasing becomes short and then the time for erasing the data can be made short.

According to the invention mentioned in claim 2, where random unit data are once repeatedly continuously written in a memory to obtain a record data for erasing and the thus obtained data are read from the memory and written in the recording medium, so that the time for writing the data for erasing on the recording medium can be made short, then it will be ended in that the time for the data erasing operation becomes short.

According to the invention mentioned in claim 3, the time for erasing the data recorded in hard disks can be made short.

According to the invention mentioned in claim 4, the random unit data settled to be two bytes, so that the time for producing random unit data becomes short.

According to the invention mentioned in claim 5, the data for erasing can be prepared with a small number of operating steps and the time for preparing data becomes short.

According to the invention mentioned in claim 6, all data recorded on the recording medium can be erased.

According to the invention mentioned in claims 7 and 9, the data recorded on the recording medium can be erased more surely by repeatedly carrying out the erasing operation with different type of the random unit data.

What is claimed is:

1. A data eraser for erasing data recorded on a data recording medium comprising: a random data producing means for producing a predetermined unit amount of random data, a recording data producing means for producing data for erasing on the basis of said random unit data produced in said random data producing means, and a data recording means for recording the thus produced data for erasing on the recording medium.

2. A data eraser according to claim 1 further comprising a memory for storing said data for erasing, wherein said data recording means records the data for erasing stored in said memory on the data recording medium.

3. A data eraser according to claim 1 or 2, wherein said recording medium is hard disks.

4. A data eraser according to anyone of claims 1 to 3, wherein said predetermined unit amount of random data is 2 bytes.

5. A data eraser according to anyone of claims 1 to 4, wherein said data for erasing is constituted of a plurality of random unit data which are repeatedly and continuously produced.

6. A data eraser according to anyone of claims 1 to 5, wherein said recording data producing means records the data for erasing on a whole area of said recording medium.

7. A data eraser according to anyone of claims 1 to 6 further comprising an erasing process controlling means for setting a number of the erasing operation to be performed; and wherein said erasing operation comprises a step for producing a new random data in said random unit data producing means and a step for writing said new random data on a whole area of said data recording medium.

8. A data erasing program for erasing data recorded on a data recording medium comprising a first step for producing a predetermined unit amount of random data; a second step for producing data for erasing by repeatedly collecting said random unit data; and a third step for recording the thus produced data for erasing on the recording medium.

9. A data erasing program according to claim 8, wherein said first to third steps are repeatedly performed plural times.
